(19) United States
(12) Patent Application Publication
(10) Pub. No.: US 2012/0192852 A1
(43) Pub. Date: Aug. 2, 2012

(54) CHARCOAL IGNITION DEVICE

(76) Inventors: Jason Porter Whitmire, Piedmont, SC (US); Ryan T. Harrison, Anderson, SC (US); Robert E. McCracken, Anderson, SC (US); Kenneth M. Brazell, Piedmont, SC (US); Scott Kippes, Anderson, SC (US); Mark Huggins, Anderson, SC (US); Taku Ohi, Greer, SC (US); Eric Lagman, Anderson, SC (US)

(21) Appl. No.: 13/363,919

(22) Filed: Feb. 1, 2012

Related U.S. Application Data
(60) Provisional application No. 61/438,330, filed on Feb. 1, 2011.

(51) Int. Cl. A47J 37/07; F04D 13/06; F23Q 13/00

(52) U.S. Cl. 126/25 B; 417/411; 417/423.14

(57) ABSTRACT

A charcoal ignition device generally includes a housing having a wall defining an interior cavity and an exterior surface. A blower assembly has an inlet end and an outlet end, with the outlet end in fluid communication with the interior cavity. The blower assembly includes a motor and a blower coupled to the motor. A battery receptacle is in electrical communication with the electric motor. The battery receptacle is configured to receive a rechargeable power-tool battery pack.

### CROSS REFERENCE TO RELATED APPLICATIONS

The present application claims priority to U.S. Provisional Patent Application No. 61/438330, filed Feb. 1, 2011, the contents of which are hereby incorporated by reference.

### FIELD

The present invention relates to outdoor cooking and grilling. More specifically, the invention generally relates to the ignition of solid fuels, such as charcoal, for use with an outdoor grill. When igniting charcoal briquettes, for example, the introduction of a forced air flow can greatly increase the speed with which sustained ignition occurs and a desired temperature for grilling is reached.

### SUMMARY

In one independent embodiment, a charcoal ignition device generally includes a housing having a wall defining an interior cavity and an exterior surface, a blower assembly having an inlet end and an outlet end, the outlet end being in fluid communication with the interior cavity, the blower assembly including a motor and a blower coupled to the motor, and a battery receptacle in electrical communication with the electric motor, the battery receptacle being configured to receive a rechargeable power-tool battery pack.

In another independent embodiment, a charcoal ignition device generally includes a housing having a wall defining an interior cavity and an exterior surface, a support member disposed within the interior cavity for supporting a solid fuel to be ignited, a handle coupled to the housing, a blower assembly having an inlet end and an outlet end, with the outlet end being in fluid communication with the interior cavity, the blower assembly including a motor and a blower coupled to the motor, and a power tool battery pack supportable on the housing and electrically connectable to the motor to supply power to the motor.

In yet another independent embodiment, an electrical combination generally includes a power tool, a charcoal ignition device, and a battery pack selectively connectable to the power tool and to the charcoal ignition device. The power tool may include a tool housing and a tool motor supported by the tool housing and operable to drive a tool. The charcoal ignition device may include a device housing having a wall defining an interior cavity and an exterior surface, a blower assembly having an inlet end and an outlet end, the outlet end being in fluid communication with the interior cavity, the blower assembly including a device motor and a blower coupled to the device motor. The battery pack is supportable by the tool housing and electrically connectable with the tool motor to supply power to the tool motor. The battery pack is also supportable by the device housing and electrically connectable to the device motor to supply power to the device motor.

Other independent aspects of the invention will become apparent by consideration of the detailed description and accompanying drawings.

### BRIEF DESCRIPTION OF THE DRAWINGS

FIG. 1 is a perspective view of a charcoal ignition device.

FIG. 2 is a top view of the device shown in FIG. 1.

FIG. 3 is a cross sectional view of the device shown in FIG. 2, taken generally along line 3-3 in FIG. 2.

FIG. 4 is a perspective view of an alternative embodiment of a charcoal ignition device.

FIG. 5 is a bottom view of the device shown in FIG. 4.

FIG. 6 is a photograph of the device shown in FIG. 4, in use.

FIG. 7 is a perspective view of another alternative embodiment of a charcoal ignition device.

FIG. 8 is a top view of the device shown in FIG. 7.

FIG. 9 is cross sectional view of the device shown in FIG. 8, taken generally along line 9-9 in FIG. 8.

FIG. 10 is a cross sectional view of a power tool.

FIG. 11 is a perspective view of a battery.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways.

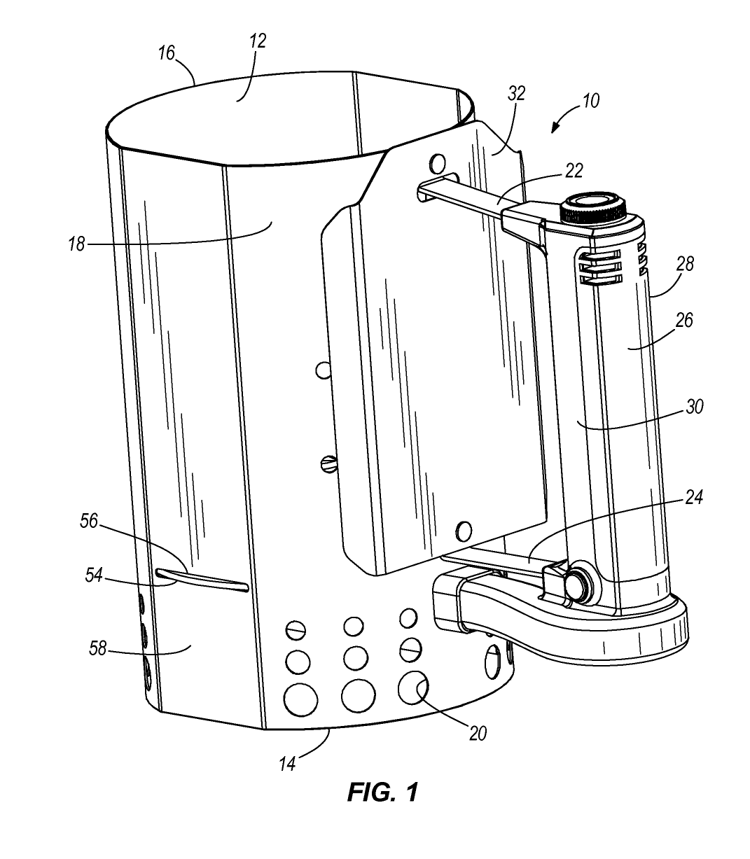

FIG. 1 illustrates a charcoal ignition device or a charcoal chimney 10, which may be used, for example, during the ignition of charcoal or other solid fuels. The charcoal chimney 10 includes a hollow housing 12 having a first end 14, a second end 16, and a substantially cylindrical wall 18 extending between the first end 14 and the second end 16. The housing 12 may be formed, for example, of a sheet metal, such as stainless or non-stainless alloy steel, or other metals. A plurality of perforations 20 are arranged adjacent the first end 14 and extend through the cylindrical wall 18. The perforations 20 allow for the passage of air into the housing 12 from an exterior of the housing 12 to an interior cavity when the charcoal chimney 10 is sitting, for example, with the first end 14 on a flat surface.

A first handle support member 22 and a second handle support member 24 extend outwardly from housing 12, substantially normal to the cylindrical wall 18. A handle 26 extends between the support members 22, 24. The handle 26 may be constructed from a thermally-insulating material, such as a plastic or wood. In the illustrated embodiment, the handle 26 includes gripping portions 28 that may be over-molded with the surrounding handle portions 30.

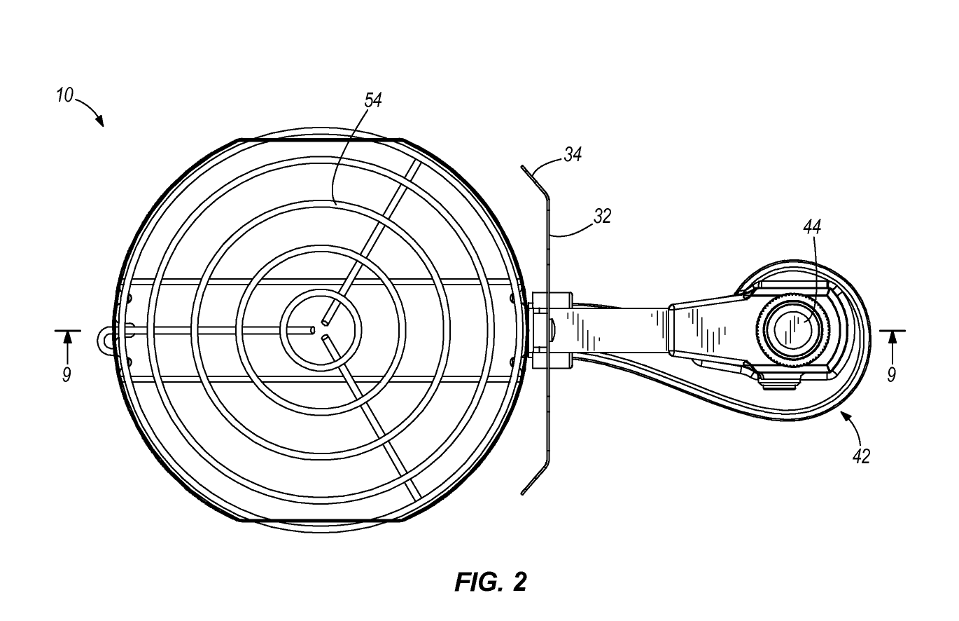

A heat shield 32 is disposed between the cylindrical wall 18 of the housing 12 and the handle 26. The heat shield 32 reduces the amount of heat transferred from the housing 12 to the handle 26. As illustrated in FIG. 2, end portions 34 of the heat shield 32 are bent to re-direct radiated heat back towards the housing 12.

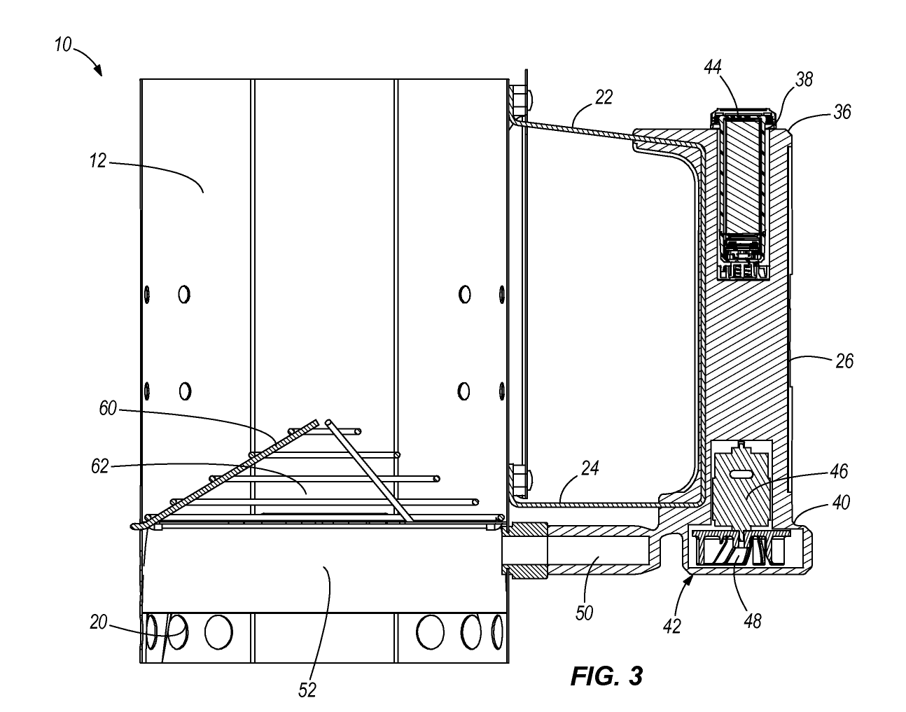

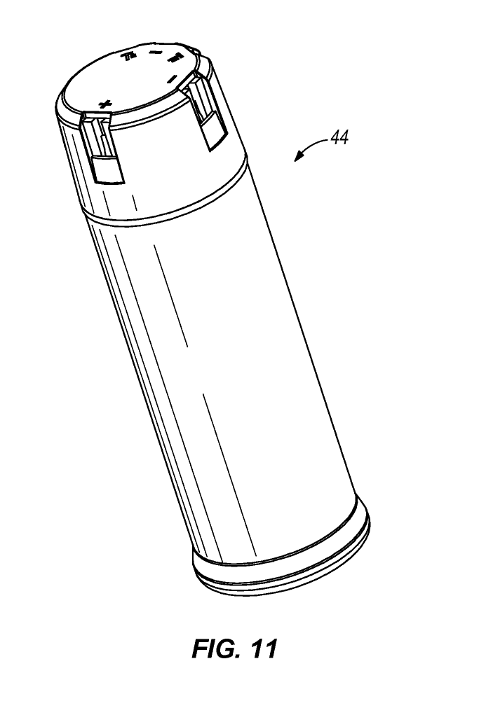

As shown in FIG. 3, a handle first end 36 includes a battery receptacle 38, and a handle second end 40 supports a blower assembly 42. The battery receptacle 38 is configured to receive a replaceable battery or battery pack 44. Referring to FIG. 11, the battery pack 44 may be, for example, a 4V Lithium Ion battery back such as a Ryobi™ TEK4™ battery pack. A cover (not shown but similar in shape to the end of the battery pack 44) may be provided to close (e.g., cover, plug, etc.) the open end of the battery receptacle 38, at least when a battery pack 44 is not supported in the receptacle 38, to prevent debris from entering the battery receptacle 38 and possibly interfering with electrical and/or mechanical connection of the battery pack 44 and the battery receptacle 38.

Referring to FIG. 3, the battery pack 44 is selectively, electrically coupled to the blower assembly 42, such as by a switch or other control device. The blower assembly 42 includes an electric motor 46 and a blower 48. In the illustrated embodiment, the blower 48 is a centrifugal type blower. The blower 48 directs a forced air flow through an air conduit 50 coupled to the housing 12. The air conduit 50 discharges to a ventilated manifold 52 within the housing 12, thereby supplying a forced airflow to the housing 12.

As also illustrated in FIG. 3, a grate 54 is disposed within the housing 12, above the manifold 52. Referring to FIG. 1, the grate 54 engages and is supported by elongate cutouts 56 formed in flat portions 58 of the substantially cylindrical wall 18. The grate 54 is configured to support charcoal briquettes (not shown) and provides separation between the manifold 52 and the briquettes. The grate 54 has generally frusto-conical profile 60, thereby forming an air cavity 62 above the manifold 52.

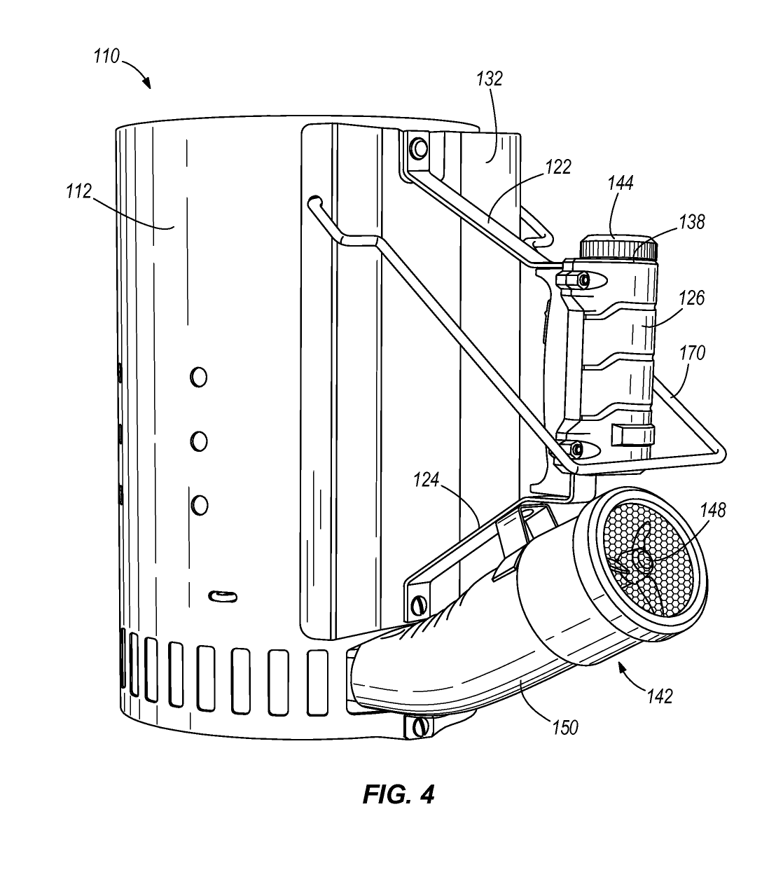

FIGS. 4-6 illustrate an alternative embodiment of a charcoal chimney 110. The charcoal chimney 110 may be similar to the charcoal chimney 10, described above (and to the charcoal chimney 210, described below) and shown in the respective figures, and common elements have the same reference number plus “100”. As shown in FIG. 4, the charcoal chimney 110 includes a housing 112, a first handle support member 122, a second handle support member 124, a handle 126, and a heat shield 132. The handle 126 includes a receptacle 138 for receiving a battery pack 144.

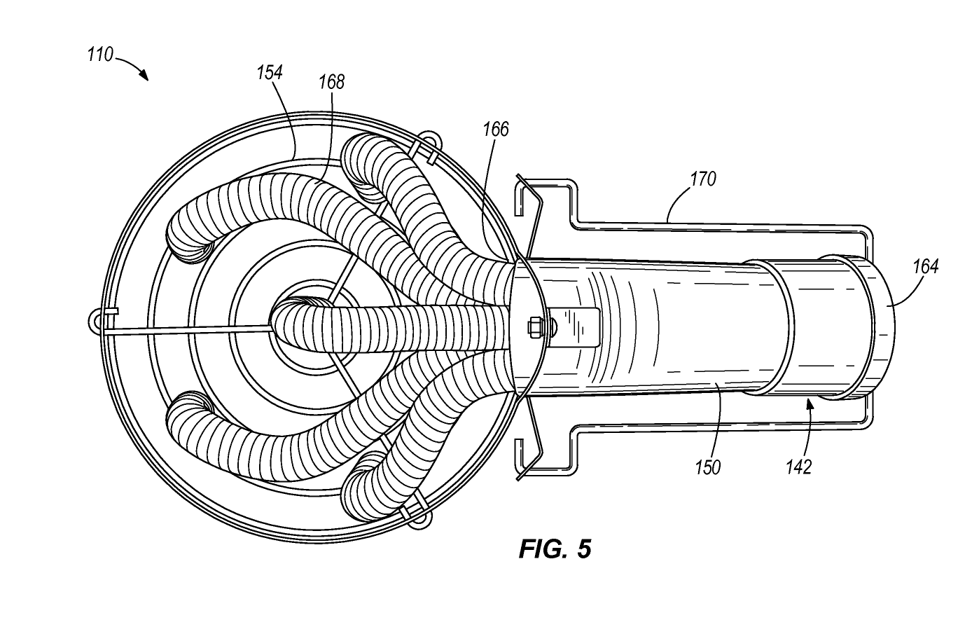

The battery pack 144 is selectively, electrically coupled to a blower assembly 142. In the embodiment of FIGS. 4-6, the blower assembly 142 includes an axial blower 148. A motor (not shown but similar to the motor 46 shown in FIG. 3) is disposed within an air conduit 150 to rotate the axial blower 148. The air conduit 150 has a first end 164 at which the axial blower 148 draws suction. As shown in FIG. 5, the air conduit 150 discharges, at a second end 166, into a plurality of air distribution tubes 168. The air distribution tubes 168 are arranged under a grate 154. The air distribution tubes 168 are configured and arranged to discharge a forced airflow to charcoal supported by the grate 154.

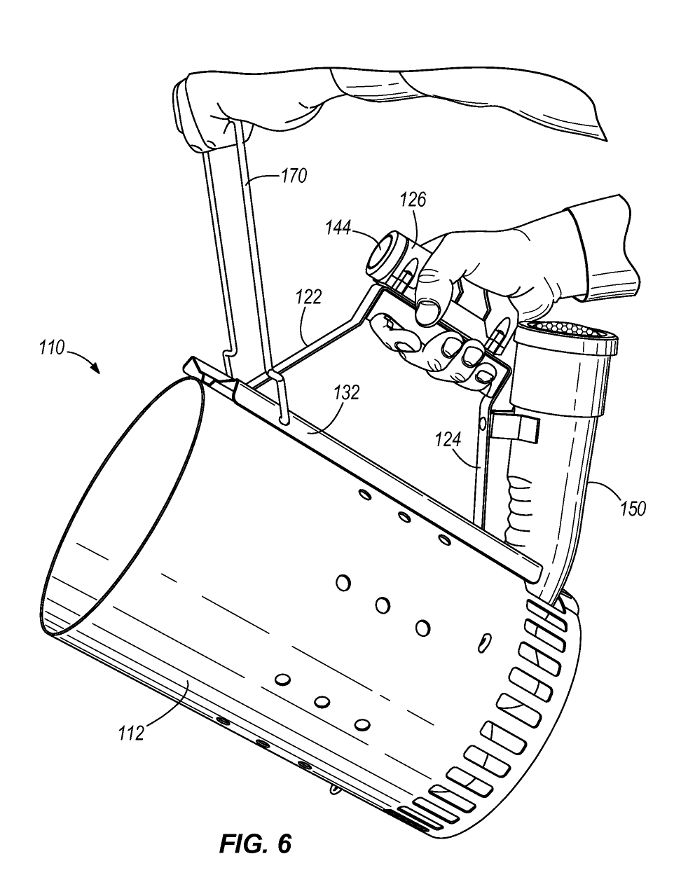

The charcoal chimney 110 also includes a support arm 170. As shown in FIGS. 4 and 6, the support arm 170 is pivotally coupled to the heat shield 132. In a first position (shown in FIG. 4), the support arm 170 pivots below the handle 126. In a second position (shown in FIG. 6), the support arm 170 is pivoted above the handle 126. In the second position, the support arm 170 provides a grip for a user to support the charcoal chimney 110 when, for example, pouring ignited charcoal into a grill.

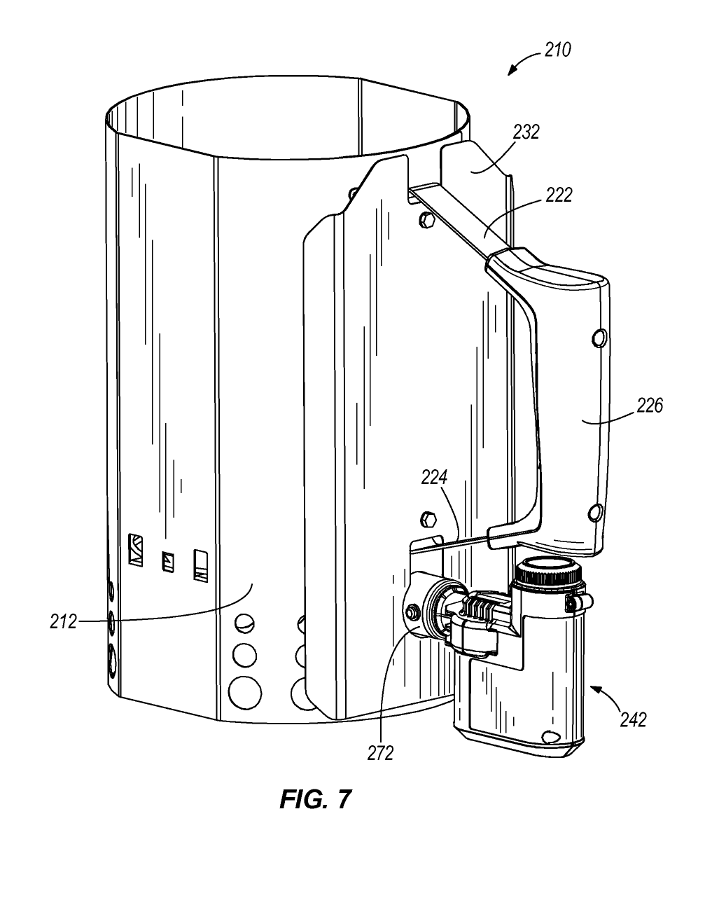

FIGS. 7-9 illustrate another alternative construction of a charcoal chimney 210. The charcoal chimney 210 may be similar to the charcoal chimneys 10, 110 described above, and shown in the respective figures, and common elements have the same reference number plus “200”. The charcoal chimney 210 includes a housing 212, a first handle support member 222, a second handle support member 224, a handle 226, and a heat shield 232.

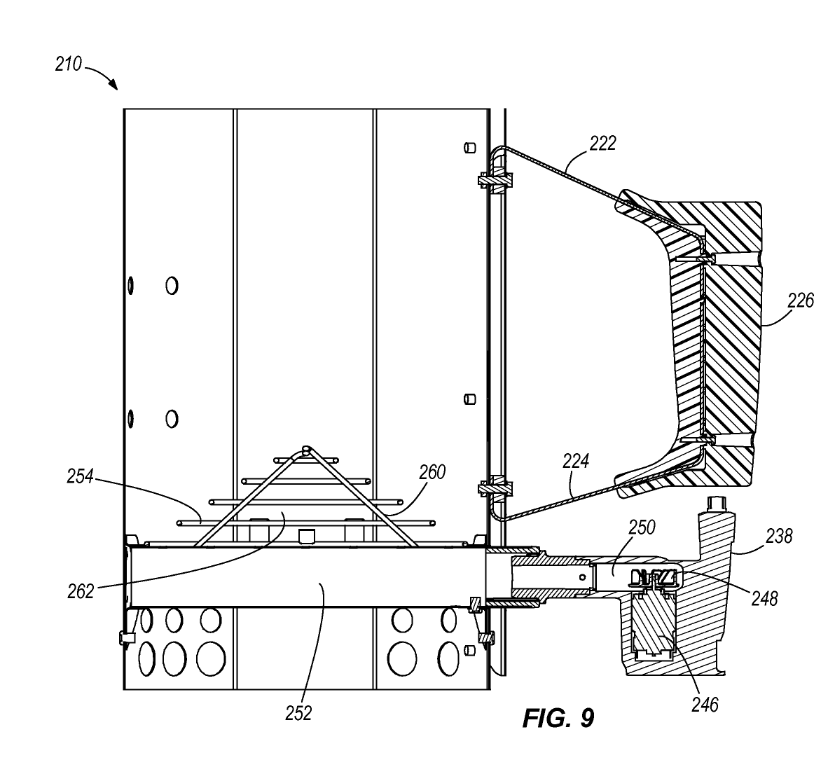

A unitary blower assembly 242 is detachably coupled to the housing 212, below the handle 226. Referring to FIG. 9, the unitary blower assembly 242 includes a battery receptacle 238, a blower 248, and a motor 246. Referring to FIG. 7, the unitary blower assembly 242 is selectively coupled to the housing 212 via a quick detachment mechanism 272, such as a quarter-turn coupling. As shown in FIG. 9, when the blower assembly 242 is coupled to the housing 212, an air conduit 250 of the blower assembly 242 is substantially aligned and in fluid communication with a manifold tube 252

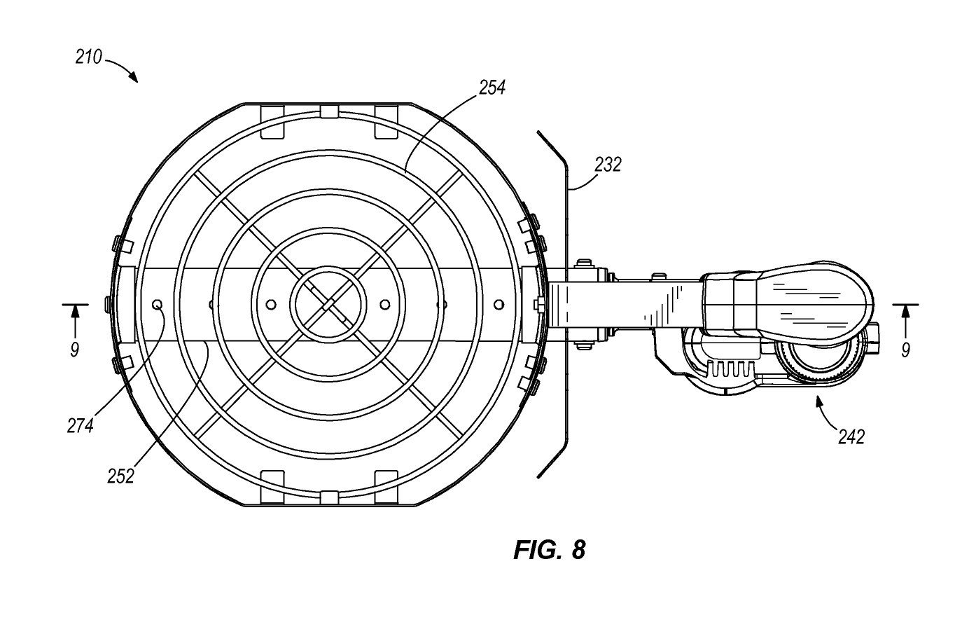

As best illustrated in FIG. 8, the manifold tube 252 includes a plurality of apertures 274 for supplying forced air from the blower assembly 242 to the housing 212. A grate 254 is disposed within the housing 212 above the manifold 252. The grate 254 is configured to support charcoal briquettes and provides separation between the manifold 252 and the briquettes. Referring to FIG. 9, the grate 254 has frusto-conical profile 260, thereby forming an air cavity 262 between the briquettes and the manifold 252.

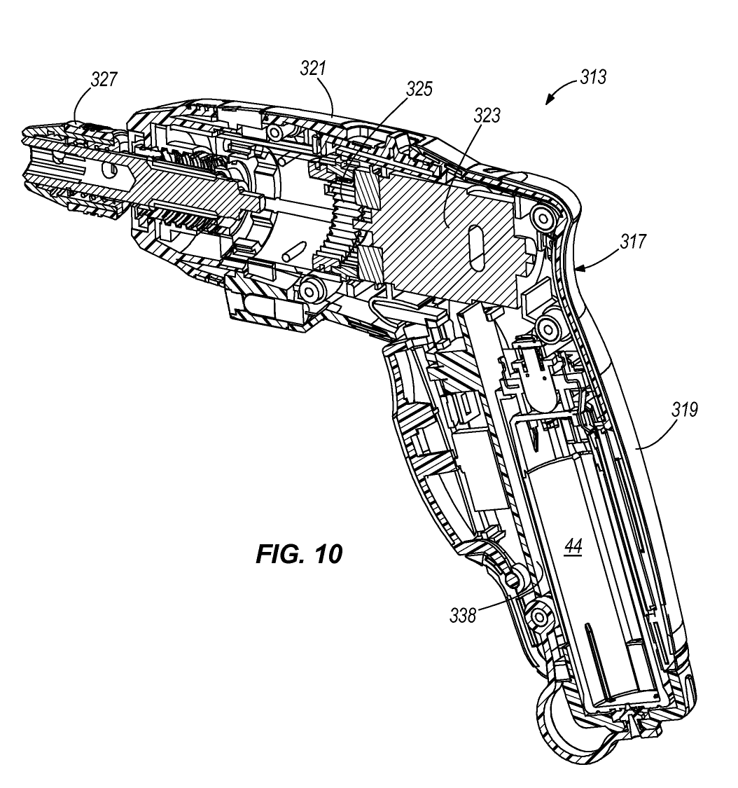

Referring to FIG. 10, a power tool, for example, a drill/driver 313 includes a housing 317. The housing 317 includes a handle portion 319 and a drive portion 321. The housing drive portion 321 supports a tool motor 323. The tool motor 323 is drivingly coupled to a drive train 325 and a chuck assembly 327 to support a tool (e.g., a drill bit) for working on a workpiece. The handle portion 319 includes a battery receptacle 338. The battery receptacle 338 is substantially the same as the battery receptacle 38 (FIGS. 3-4) and is similarly configured to receive a battery pack 44, such as, for example, a 4V Lithium Ion battery back such as a Ryobi™ TEK4™ battery pack. Thus, the battery pack 44 (see FIG. 11) may be used in combination with multiple devices, including, for example, the power tool (the drill/driver 313 (FIG. 10)) and the charcoal chimney 10, 110 or 210 (FIG. 1).

Thus, the invention may generally provide, among other things, a charcoal chimney with a battery powered blower assembly. Various independent aspects of the invention are set forth in the following claims:

1. A charcoal ignition device comprising:
a housing having a wall defining an interior cavity and an exterior surface;
a blower assembly having an inlet end and an outlet end, the outlet end being in fluid communication with the interior cavity, the blower assembly including a motor and a blower coupled to the motor; and
a battery receptacle in electrical communication with the electric motor, the battery receptacle being configured to receive a rechargeable power-tool battery pack.

2. The device of claim 1, further comprising a power tool battery pack supportable by the battery receptacle and electrically connectable to the motor to supply power to the motor.

3. The device of claim 1, further comprising a handle assembly coupled to the housing.

4. The device of claim 3, wherein the handle assembly includes a first support member coupled to the housing, a second support member coupled to the housing, and a handle member extending between the first support member and the second support member.

5. The device of claim 4, wherein the receptacle is at least partially defined by the handle member.

6. The device of claim 3, further comprising a heat shield disposed between the exterior surface and the handle assembly.

7. The device of claim 1, wherein the blower assembly includes a centrifugal blower.

8. The device of claim 1, wherein the blower assembly includes an axial blower.

9. The device of claim 1, wherein the blower assembly includes the receptacle.

10. The device of claim 1, further comprising an air conduit disposed between the outlet end and the interior cavity.

11. The device of claim 10, wherein the air conduit includes a plurality of tubular conduit members.

12. The device of claim 1, wherein the wall defines a plurality of apertures.

13. The device of claim 1, further comprising a support member disposed within the interior cavity for supporting a solid fuel to be ignited.

14. A charcoal ignition device comprising:
a housing having a wall defining an interior cavity and an exterior surface;
a support member disposed within the interior cavity for supporting a solid fuel to be ignited;
a handle coupled to the housing;
a blower assembly having an inlet end and an outlet end, the outlet end being in fluid communication with the interior cavity, the blower assembly including a motor and a blower coupled to the motor; and
a power tool battery pack supportable on the housing and electrically connectable to the motor to supply power to the motor.

15. The device of claim 14, further comprising a manifold coupled to the outlet end, the manifold distributing air from the outlet end to the interior cavity.

16. The device of claim 15, wherein the manifold includes a tubular body defining a plurality of apertures.

17. The device of claim 14, further comprising a plurality of air distribution tubes, each air distribution tube in fluid communication with the outlet end and the interior cavity.

18. The device of claim 14, wherein the support member has frusto-conical profile.

19. The device of claim 14, wherein the support member includes a grate coupled to the wall.

20. The device of claim 14, further comprising a receptacle configured to receive the power tool battery pack, the battery receptacle being coupled to handle.

21. An electrical combination comprising:
a power tool including
a tool housing, and
a tool motor supported by the tool housing and operable to drive a tool;
a charcoal ignition device including
a device housing having a wall defining an interior cavity and an exterior surface; and
a blower assembly having an inlet end and an outlet end, the outlet end being in fluid communication with the interior cavity, the blower assembly including a device motor and a blower coupled to the device motor; and
a battery pack selectively connectable to the power tool and to the charcoal ignition device, the battery pack being supportable by the tool housing and electrically connectable with the tool motor to supply power to the tool motor, the battery pack being supportable by the device housing and electrically connectable to the device motor to supply power to the device motor.

22. The combination of claim 21, wherein the battery pack includes at least one pack electrical connector, wherein the power tool further includes a tool battery pack support configured to receive the battery pack and a tool electrical connector electrically connectable to the pack electrical connector when the battery pack is supported on the tool battery pack support, and wherein the device further includes a device battery pack support configured to receive the battery pack and a device electrical connector electrically connectable to the pack electrical connector when the battery pack is supported on the device battery pack support.

23. The combination of claim 22, wherein the tool battery pack support includes a tool receptacle configured to receive the battery pack, the tool electrical connector being positioned in the tool receptacle, and wherein the device battery pack support includes a device receptacle configured to receive the battery pack, the device electrical connector being positioned in the device receptacle.
